(19) United States
(12) Patent Application Publication
(10) Pub. No.: US 2010/0103102 A1
(43) Pub. Date: Apr. 29, 2010

(54) DISPLAYING METHOD AND DISPLAY CONTROL MODULE

(75) Inventors: I-Fen Shih, Taoyuan County (TW); Shih-Hsian Yang, Taoyuan County (TW); Chin-Ku Lin, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/539,615

(22) Filed: Aug. 12, 2009

(30) Foreign Application Priority Data
Oct. 27, 2008 (TW) 97141233

(51) Int. Cl. G09G 5/08

(52) U.S. Cl. 345/158

(57) ABSTRACT

A displaying method for a portable device under a standby condition is provided. The portable device includes a display unit displaying a first standby frame. The method includes steps of sensing a physical motion of the portable device. Then, the physical motion is identified as an operation command. Finally, according to the operation command, a corresponding operation is executed to change the first standby frame displayed on the display unit.

### CROSS-REFERENCE TO RELATED APPLICATION

This application claims the priority benefit of Taiwan application serial No. 97141233, filed on Oct. 27, 2008. The entirety of the above-mentioned patent application is hereby incorporated by reference herein and made a part of this specification.

### BACKGROUND OF THE INVENTION

1. Field of the Invention

The present invention relates to a displaying method and a display control module. More specifically, the present invention relates to a displaying method of a display unit in a portable device and a display control module thereof.

2. Description of Related Art

As development of communication technology advances, cellular phones and personal digital assistants (PDAs) with communication capacity obtain more diverse functions. Communication devices such as cellular phones and PDAs not only provide a user with a simple communication, but also save missed call information, or receive text messages when the user is unavailable during a conference, for instance. Moreover, the operating system of cellular phones or PDAs provide personal calendar that allows the user to enter daily notes and important schedules. Then, the operating system of cellular phones or PDAs sends out a reminder at appropriate time regarding the daily notes or meeting schedules to remind the user of upcoming events.

Generally, when the cellular phone or the PDA is under a standby condition, browsing of the missed calls, text messages, or schedule reminders would require the user to at least free a finger, stare at the keypad, change from the standby condition to an operating mode, or even go through a series of keypad pressing to unlock the screen and check the information. As a result, the operation of cellular phone and PDA would be inconvenient and the user may neglect reminders for important events or scheduled meetings.

### SUMMARY OF THE INVENTION

The present invention is to provide a displaying method for a user to browse information with specific physical motions of a portable device without canceling the standby condition.

The present invention is also related to a display control module that allows rapid information to be browsed when a specific physical motion is exerted on the portable device.

The present invention provides a displaying method, suitable for a portable device under a standby condition, where the portable device includes a display unit displaying a first standby frame. This method includes first sensing a physical motion of the portable device. Then, based on the physical motion, a corresponding operation is executed to change the first standby frame displayed on the display unit.

According to an embodiment of the displaying method of the present invention, the operation includes step of displaying an information frame or a second standby frame.

According to an embodiment of the displaying method of the present invention, the information frame includes a missed call information frame, a new message information frame, and an event reminder information frame.

According to an embodiment of the displaying method of the present invention, the second standby frame is a multiple-dimensional image displaying the first standby frame at a viewing angle.

According to an embodiment of the displaying method of the present invention, the viewing angle is related to a motion angle of the physical motion.

According to an embodiment of the displaying method of the present invention, the standby condition includes a keypad-locked condition and a screen-locked condition.

According to an embodiment of the displaying method of present invention, the physical motion includes rotating the portable device around an axis of the portable device with an angle.

According to an embodiment of the displaying method of the present invention, the physical motion includes a swing motion.

According to an embodiment of the displaying method of the present invention, the physical motion includes a vibrating motion.

According to an embodiment of the displaying method of the present invention, the portable device includes a smart phone, a PDA, a PDA cellular phone and a touch phone.

The present invention further provides a display control module, suitable for a portable device with a display unit. The display control module includes a motion sensing device and a command operating module. The motion sensing device, where the portable device is under a standby condition, senses a physical motion of the portable device. In the mean time, the displaying unit displays a first standby frame under the standby condition. On the other hand, a motion analysis module is used to identify the physical motion as an operation command. In addition, the command operating module executes an operation corresponding to the physical motion, and changes the first standby frame displayed on the display unit of the portable device under the standby condition.

According to an embodiment of the display control module of the present invention, the operation includes a step of displaying an information frame or a second standby frame.

According to an embodiment of the display control module of the present invention, the information frame includes a missed call information frame, a new message information frame, and an event reminder information frame.

According to an embodiment of the display control module of the present invention, the second standby frame is a multiple-dimensional image displaying the first standby frame at a viewing angle.

According to an embodiment of the display control module of the present invention, the viewing angle is related to a motion angle of the physical motion.

According to an embodiment of the display control module of the present invention, the standby condition includes a keypad-locked condition and a screen-locked condition.

According to an embodiment of the display control module of present invention, the physical motion includes rotating the portable device around an axis of the portable device with an angle.

According to an embodiment of the display control module of the present invention, the physical motion includes a swing motion.

According to an embodiment of the display control module of the present invention, the physical motion includes a vibrating motion.

According to an embodiment of the display control module of the present invention, the portable device includes a smart phone, a PDA, a PDA cellular phone and a touch phone.

According to an embodiment of the display control module of the present invention, the motion sensing device includes a gravity sensing device.

The present invention applies the motion sensing device disposed in the portable device to sense a specific physical motion performed by the user handling the portable device, and to respond to the physical motion with corresponding operation; thereby simplifies the application process of the user and creates greater convenience of the portable device.

To make the above and other aims, features, and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing one embodiment of the displaying method of the present invention.

FIGS. 2A to 2D are diagrams showing one embodiment of the physical motion and the corresponding operation change of the portable device of the present invention.

FIG. 3 is a flow chart showing one embodiment of the display control module of the present invention.

FIGS. 4A to 4B are diagrams showing one embodiment of the physical motion and the corresponding operation change of the portable device of the present invention.

### DESCRIPTION OF EMBODIMENTS

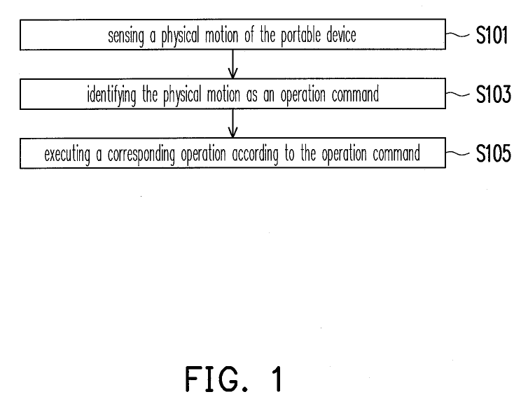

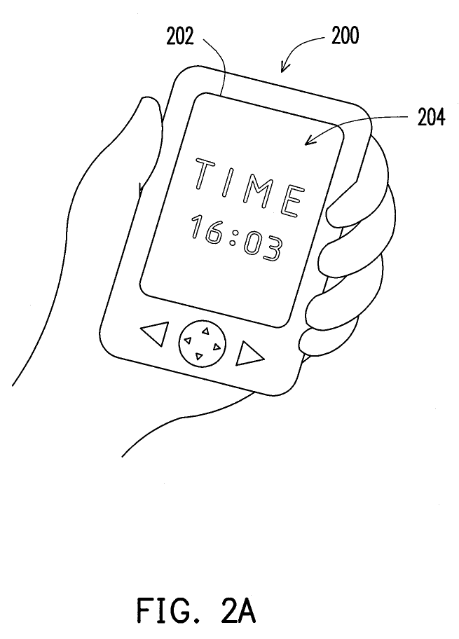

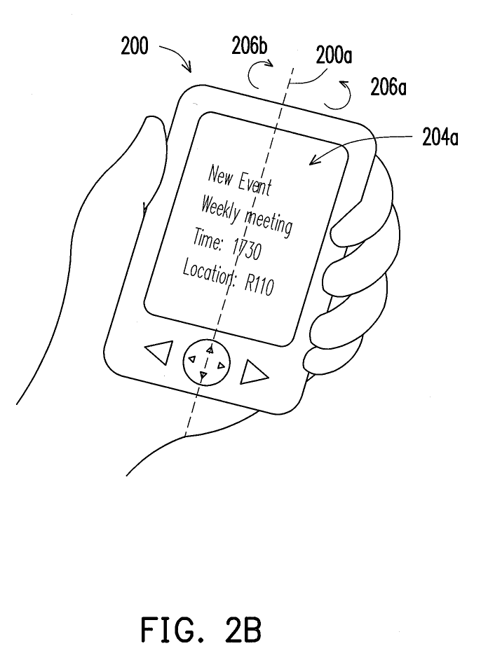

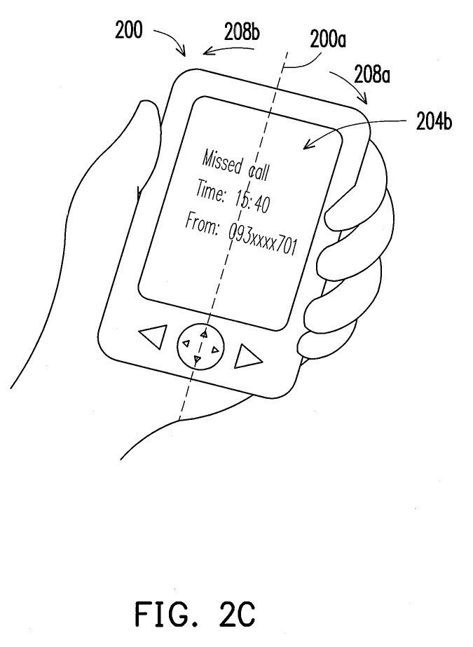

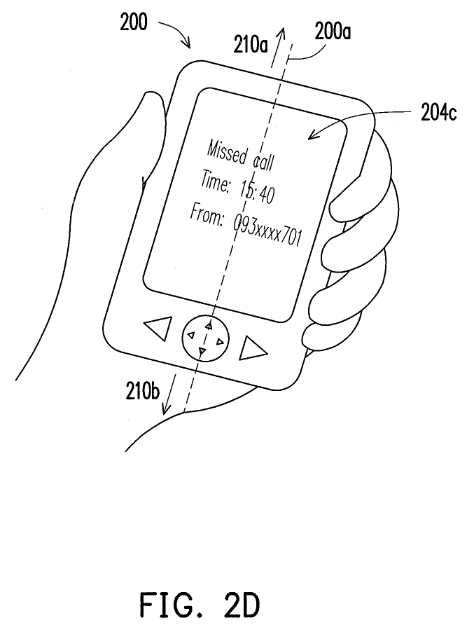

FIG. 1 is a flow chart showing one embodiment of the displaying method of the present invention. Referring to FIG. 1, first, a portable device is provided. As indicated in FIG. 2A, the portable device 200 has a display unit 202, and the portable device 200 is under a standby condition while the display unit 202 displays a standby frame 204. The aforementioned portable device 200 includes a smart phone, a PDA, a PDA cellular phone and a touch phone. The standby frame 204 includes a motion clock frame as shown in FIG. 2A. In another embodiment, the standby frame 204 may also be a multiple-dimensional static or dynamic screen saver program. In an alternative embodiment, the standby condition includes a keypad-locking condition or a screen-locking condition. In step S101, the portable device 200 senses the physical motion performed by a user. The physical motion integrates with the portable device 200 to perform spatial actions including moving, rotating and swinging.

Moreover, in step S103, the sensed physical motion is identified to be an operation command. Next, in step S105, according to the aforementioned operation command, a corresponding operation correlated to the operation command is executed, and thus the standby frame 204 displayed on the display unit 202 is changed. The aforementioned operation includes displaying an information frame or changing from the standby frame 204 to another standby frame, for example. Furthermore, the aforementioned information frame includes a missed call information frame, a new message information frame, and an event reminder information frame.

Referring to FIG. 2B, the aforementioned physical motion includes rotating the portable device 200 around an axis 200a of the portable device with an angle. The axis 200a passes through the portable device 200. In the embodiment, the user holds the portable device 200 and turns the portable device 200 at an angle along an arrow 206a or 206b. The original standby frame 204 (as shown in FIG. 2A) then changes to an event reminder information frame 204a, where the event reminder information includes event themes (for example, weekly meeting, time and place).

In another embodiment, the aforementioned physical motion includes a swing motion. For example, referring to FIG. 2C, a point on the axis 200a of the aforementioned portable device 200 is set as the swinging center and swings along an arrow 208a or 208b, which would result in the changing of the original standby frame 204 (as shown in FIG. 2A) to a missed call information frame 204b, where the missed call information includes time to receive missed call information, caller number or caller id.

In still another embodiment, the aforementioned physical motion further includes a vibrating motion. Referring to FIG. 2D, the vibration following an arrow 210a or 210b along an axis (e.g. the aforementioned axis 200a) of the portable device 200 would result in the changing of the original standby frame 204 (as shown in FIG. 2A) to a new message information frame 204c, where the new message information includes time to receive new messages, caller number, or caller id.

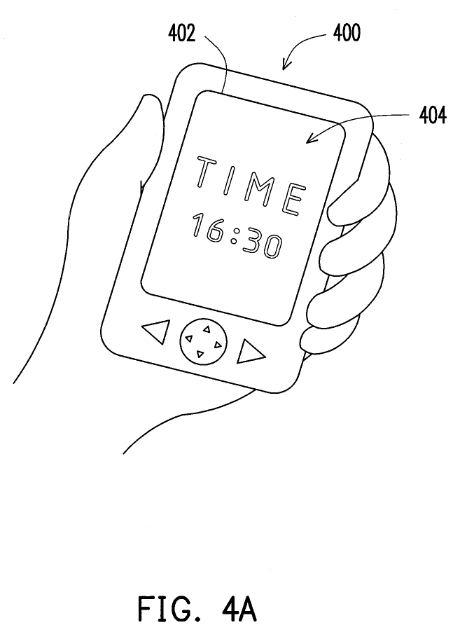

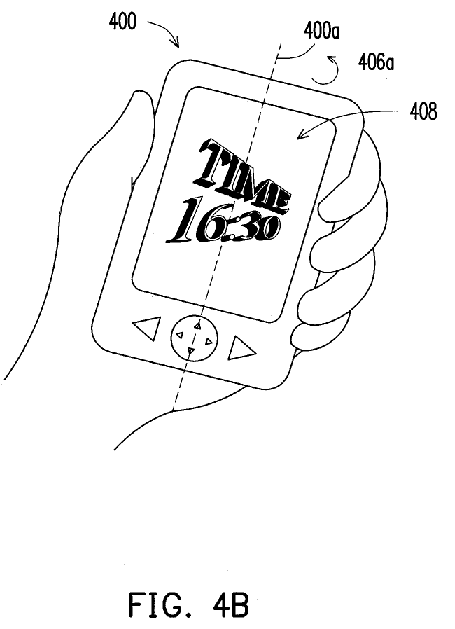

Furthermore, in yet still another embodiment, the sensed physical motion mentioned above allows the portable device to change from the original standby frame to another standby frame, where the changed standby frame is a multiple-dimensional image displaying the original standby frame at a viewing angle. As indicated in FIG. 4A, in the embodiment, the original standby frame 404 may be displaying a plane two-dimensional digital clock. At this time, the user exerts a physical motion 406 (as shown with an arrow 406 in FIG. 4B) that includes rotating the portable device 400 around a axis 400a of the portable device at an angle in the counter-clockwise direction, and where the axis 400a passes through the portable device 400. When the physical motion 406 is sensed, the plane two-dimensional digital clock standby frame 404 displayed on the display unit 402 responds to the physical motion 406 and display a three-dimensional image 408 at a viewing angle of the original plane two-dimensional digital clock standby frame 404. In other words, based on the physical motion generated by the user on the portable device, the original multiple-dimensional (at least two-dimensional) standby frame displays different visual effects at different angles according to the direction of the physical motion of the portable device. As a consequence, the aforementioned viewing angle is related to a motion angle of the physical motion.

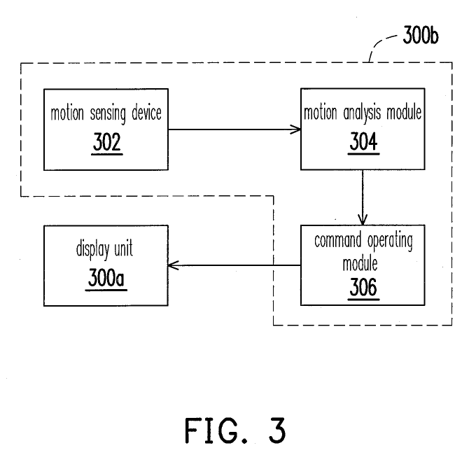

FIG. 3 is a flow chart showing one embodiment of the display control module of the present invention. Referring to FIG. 3, a display control module 300b is disposed in a display unit 300a of a portable device 300. The display control module 300b includes a motion sensing device 302, a motion analysis module 304, and a command operating module 306. When the aforementioned motion sensing device 302, disposed in the portable device 300, is under a standby condition, the motion sensing device senses a physical motion generated by the user through the portable device 300. In addition, the display unit 300a displays a standby frame (as shown in the standby frame 204 in FIG. 2A) under the standby condition. Yet, the motion sensing device 302 includes a gravity sensing device. On the other hand, the motion analysis module 304 is used to identify the physical motion as an operation command. Moreover, the command operating module 306 executes an operation corresponding to the operation command to change the standby frame displayed on the display unit 300a. In the aforementioned display control module 300, the operation methods and properties of the motion sensing device 302, the motion analysis module 304 and the command operating module 306 are similar to the those illustrated in the above-mentioned embodiments, and thus are not repeated herein.

In summary, the invention utilizes the motion sensing device disposed in the portable device, and senses specific physical motions generated when the user holds the portable device and responds with the corresponding operation according to the physical motion. Thus, while the portable device is under the standby condition, the user may rapidly browse information or simply change the standby frame without canceling the standby condition by generating simple and specific physical motions through the portable device. The user does not need to go through troublesome keypad pressing to cancel the standby condition and another series of keypad pressing to check information. Therefore, the operation instructions for the user would be greatly simplified, and increases the convenient of the portable device utility.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A displaying method for a portable device under a standby condition, wherein the portable device has a display unit displaying a first standby frame, the displaying method comprising:
sensing a physical motion of the portable device; and
executing an operation according to the physical motion so that the first standby frame is changed under the standby condition.

2. The displaying method according to claim 1, wherein the operation comprises displaying an information frame or a second standby frame.

3. The displaying method according to claim 2, wherein the information frame comprises a missed call information frame, a new message information frame, and an event reminder information frame.

4. The displaying method according to claim 2, wherein the second standby frame is a multiple-dimensional image displaying the first standby frame at a viewing angle.

5. The displaying method according to claim 4, wherein the viewing angle is related to a motion angle of the physical motion.

6. The displaying method according to claim 1, wherein the standby condition comprises a keypad-locked condition and a screen-locked condition.

7. The displaying method according to claim 1, wherein the physical motion comprises rotating the portable device around an axis of the portable device with an angle.

8. A display control module, suitable for a portable device having a display unit, comprising:
a motion sensing device, sensing a physical motion of the portable device while the portable device is under a standby condition, wherein the display unit displays a first standby frame under the standby condition; and
a command operating module, executing an operation corresponding to the physical motion, and changing the first standby frame displayed on the display unit of the portable device under the standby condition.

9. The display control module according to claim 8, wherein the operation comprises displaying an information frame or a second standby frame.

10. The display control module according to claim 9, wherein the information frame comprises a missed call information frame, a new message information frame, and an event reminder information frame.

11. The display control module according to claim 9, wherein the second standby frame is a multiple-dimensional image displaying the first standby frame at a viewing angle.

12. The display control module according to claim 11, wherein the viewing angle is related to a motion angle of the physical motion.

13. The display control module according to claim 8, wherein the standby condition comprises a keypad-locked condition and a screen-locked condition.

14. The display control module according to claim 8, wherein the physical motion comprises rotating the portable device around an axis of the portable device with an angle.

15. The display control module according to claim 8, wherein the motion sensing device comprises a gravity sensing device.

16. A displaying method, suitable for a portable device under a standby condition, wherein the portable device has a display unit displaying a first standby frame, the displaying method comprising:
sensing a physical motion of the portable device; and
changing the first standby frame displayed on the display unit to a multiple-dimensional image of the first standby frame at a viewing angle.

17. The displaying method according to claim 16, wherein the viewing angle is related to a motion angle of the physical motion.

18. The displaying method according to claim 16, further comprising changing the first standby frame displayed on the display unit of the portable device under standby condition according to the physical motion.

19. The displaying method according to claim 18, wherein the information frame comprises a missed call information frame, a new message information frame, and an event reminder information frame.

20. The displaying method according to claim 16, wherein the standby condition comprises a keypad-locked condition and a screen-locked condition.
